(19) United States
(12) Patent Application Publication
(10) Pub. No.: US 2014/0362030 A1
(43) Pub. Date: Dec. 11, 2014

(54) CAPACITIVE TOUCH SCREEN AND METHOD FOR MANUFACTURING THE SAME

(71) Applicant: FocalTech Systems, Ltd., Grand Cayman (KY)

(72) Inventors: Lianghua Mo, Shenzhen (CN); Guang Ouyang, Shenzhen (CN); Hua Li, Shenzhen (CN)

(73) Assignee: FocalTech Systems, Ltd., Grand Cayman (KY)

(21) Appl. No.: 14/081,984

(22) Filed: Nov. 15, 2013

(30) Foreign Application Priority Data
Jun. 6, 2013 (CN) 201310223835.9

(51) Int. Cl. G06F 3/044

(52) U.S. Cl. CPC G06F 3/044
USPC 345/174; 29/622

(57) ABSTRACT

A capacitive touch screen and a method for manufacturing the same are provided. The capacitive touch screen includes: a transparent medium; a plurality of sensing electrodes provided on a lower surface of the transparent medium, the plurality of sensing electrodes being arranged in a two-dimensional array; and a touch control chip bonded onto the lower surface of the transparent medium, wherein the touch control chip is connected with each of the plurality of sensing electrodes via a wire.

This application claims the priority to Chinese Patent Application No. 201310223835.9, entitled “CAPACITIVE TOUCH SCREEN AND METHOD FOR MANUFACTURING THE SAME”, filed with the Chinese State Intellectual Property Office on Jun. 6, 2013, which is incorporated by reference in its entirety herein.

### FIELD OF THE INVENTION

The present invention relates to the field of touch control technology, and particularly to a capacitive touch screen and a method for manufacturing the same.

### BACKGROUND OF THE INVENTION

Currently, a capacitive touch screen is widely used in various electronic products, and has gradually penetrated various fields of people's working and life. The size of the capacitive touch screen has become increasingly bigger, ranging from 3-6.1 inches of a smart phone to about 10 inches of a tablet, and the capacitive touch screen even can be applied to a smart television and the like. However, the existing capacitive touch screen has problems such as poor anti-interference performance, low scan frame rate, high manufacturing cost, and heavy weight.

### SUMMARY OF THE INVENTION

In view of the above, a capacitive touch screen and a method for manufacturing the same are provided according to embodiments of the present invention, for solving at least one of the above problems.

A capacitive touch screen provided by an embodiment of the present invention includes:

a transparent medium;

a plurality of sensing electrodes disposed on a lower surface of the transparent medium, the plurality of sensing electrodes being arranged in a two-dimensional array; and

a touch control chip bonded onto the lower surface of the transparent medium, the touch control chip being connected with each of the plurality of the sensing electrodes via a wire.

Preferably, the capacitive touch screen further includes:

a flexible circuit board connected with the touch control chip, the flexible circuit board being bonded onto the lower surface of the transparent medium via an anisotropic conductive film ACF.

Preferably, the touch control chip is connected with the wire via the ACF.

Preferably, the transparent medium is provided with a visible region, a light shielding layer is provided on the lower surface of the transparent medium, and the light shielding layer is located at the outside of the visible region.

Preferably, the touch control chip, the flexible circuit board and the wire are all provided below the light shielding layer.

Preferably, the transparent medium is a polyethylene terephthalate PET film, a polycarbonate PC film or a polymethylmethacrylate PMMA film, and the sensing electrodes is made of indium tin oxides, graphene or metal mesh.

Preferably, the transparent medium is the PET film, and the touch control chip is bonded onto a lower surface of the PET film; or

the transparent medium is the PC film, and the touch control chip is bonded onto a lower surface of the PC film; or

the transparent medium is the PMMA film, and the touch control chip is bonded onto a lower surface of the PMMA film.

Preferably, the sensing electrode is in a shape of a rectangle, a diamond, a circle or an oval, and the plurality of sensing electrodes have a same size or different sizes.

Preferably, the touch control chip is configured to detect self-capacitance of each sensing electrode.

Preferably, the touch control chip is configured to detect self-capacitance of each sensing electrode by:

driving the sensing electrodes by using a voltage source or a current source; and

detecting a voltage, a frequency or a charge quantity on the sensing electrodes.

Preferably, the touch control chip is configured to detect self-capacitance of each sensing electrode by:

driving and detecting the sensing electrode, and driving the remaining sensing electrodes simultaneously; or

driving and detecting the sensing electrode, and driving sensing electrodes around the sensing electrode simultaneously, wherein a signal for driving the sensing electrode and a signal for driving the remaining sensing electrodes simultaneously or a signal for driving the sensing electrodes around the sensing electrode simultaneously are same voltage signals or current signals, or different voltage signals or current signals.

Preferably, the voltage source or the current source has a same frequency for the plurality of sensing electrodes; or

the voltage source or the current source has two or more frequencies for the plurality of sensing electrodes.

Preferably, the touch control chip is configured to detect self-capacitance of each sensing electrode by:

detecting the plurality of sensing electrodes simultaneously; or

detecting the plurality of sensing electrodes group by group.

Preferably, the touch control chip is configured to determine a touch position according to a two-dimensional sensing array.

Preferably, the touch control chip is further configured to adjust sensitivity or dynamic range of a touch detection by means of parameters of the voltage source or the current source, wherein the parameters include any of amplitude, frequency and time sequence or a combination thereof.

A method for manufacturing a capacitive touch screen provided by an embodiment of the present invention includes:

plating a lower surface of a transparent medium with transparent conductive material, and etching the transparent conductive material to form a plurality of sensing electrodes, the plurality of sensing electrodes being arranged in a two-dimensional array; and

bonding a touch control chip onto the lower surface of the transparent medium, and connecting the touch control chip with each of the plurality of sensing electrodes via a wire.

Preferably, a flexible circuit board is bonded onto the lower surface of the transparent medium via an anisotropic conductive film ACF by utilizing a hot pressing technique, and the flexible circuit board is connected with the touch control chip.

Preferably, the connecting the touch control chip with each of the plurality of sensing electrodes via a wire includes:

connecting each of the plurality of sensing electrodes to one end of a wire, and connecting the touch control chip to the other end of the wire via an ACF.

Preferably, the method further includes, after etching the transparent conductive material to form the plurality of the sensing electrodes,

providing the transparent medium with a visible region, and providing a light shielding layer on the lower surface of the transparent medium, where the light shielding layer is located at the outside of the visible region.

Preferably, the touch control chip, the flexible circuit board and the wires are all disposed below the light shielding layer.

Preferably, the transparent medium is a polyethylene terephthalate PET film, a polycarbonate PC film or a polymethylmethacrylate PMMA film, and the transparent conductive material is indium tin oxides, graphene or metal mesh.

Preferably, the bonding a touch control chip to the lower surface of the transparent medium includes:

in a case where the transparent medium is the PET film, bonding the touch control chip onto a lower surface of the PET film;

in a case where the transparent medium is the PC film, bonding the touch control chip onto a lower surface of the PC film; or

in a case where the transparent medium is the PMMA film, bonding the touch control chip onto a lower surface of the PMMA film.

Preferably, the sensing electrode is in a shape of a rectangle, a diamond, a circle or an oval, and the plurality of sensing electrodes have a same size or different sizes.

In the embodiments of the present invention, the capacitive touch screen includes: a transparent medium; a plurality of sensing electrodes provided on a lower surface of the transparent medium, the plurality of sensing electrodes being arranged in a two-dimensional array; and a touch control chip bonded onto the lower surface of the transparent medium, where the touch control chip is connected with each of the plurality of sensing electrodes via a wire. In this way, multi-touch is achieved, while the weight and the manufacturing cost of the touch screen are reduced, the noise is significantly reduced and the signal-to-noise ratio is improved.

### BRIEF DESCRIPTION OF THE DRAWINGS

FIG. 1 is a schematic diagram of a capacitive touch screen according to an embodiment of the present invention;

FIG. 2 is a flow chart of a method for manufacturing the capacitive touch screen according to an embodiment of the present invention;

FIG. 3 is a top view of a sensing electrode array according to an embodiment of the present invention;

FIGS. 4 to 7 illustrate methods for driving sensing electrodes according to embodiments of the present invention;

FIG. 8 illustrates four application cases of the capacitive touch screen according to embodiments of the present invention;

FIG. 9 illustrates a signal flow chart of a touch control chip according to an embodiment of the present invention;

FIG. 10A illustrates an example of calculating coordinates of a touch position by using a centroid algorithm; and

FIG. 10B illustrates an example of calculating coordinates of a touch position by using a centroid algorithm in a case where noise exists.

### DETAILED DESCRIPTION OF THE INVENTION

In order to make the purpose, features and advantages of the present invention more apparent and better understood, technical solutions of the embodiments of the present invention will be described below in conjunction with the accompanying drawings of the embodiments of the present invention. It is obvious that the described embodiments are only part of embodiments of the present invention. All the other embodiments obtained by those skilled in the art based on the embodiments of the present invention without any creative work belong to the scope of protection of the present invention. For facilitating illustration, sectional views showing the structures are enlarged partially without a same scaling proportion, and the drawings are only examples, which should not be understood as limiting the scope of protection of the present invention. Furthermore, in an actual manufacturing process, three-dimensional space sizes, i.e. length, width and depth should be considered.

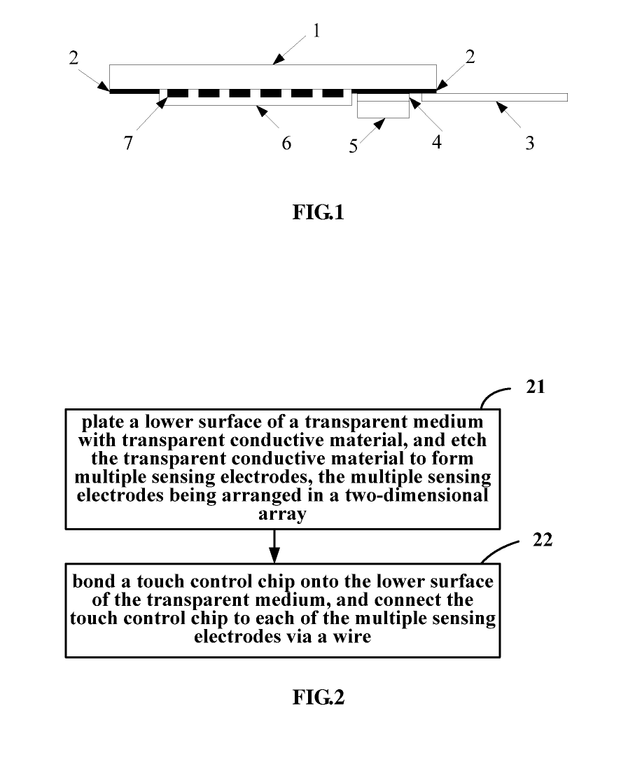

FIG. 1 is a schematic diagram of a capacitive touch screen according to an embodiment of the present invention. As shown in FIG. 1, the capacitive touch screen includes: a transparent medium 1; multiple sensing electrodes 7 provided on the lower surface of the transparent medium 1, the multiple sensing electrodes 7 being arranged in a two-dimensional array; and a touch control chip 5 bonded onto the lower surface of the transparent medium 1, the touch control chip 5 being connected to each of the multiple sensing electrodes 7 via a wire.

The transparent medium 1 may be a transparent film such as a polyethylene terephthalate (PET) film, a polycarbonate (PC) film, and a polymethylmethacrylate (PMMA) film. Multiple sensing electrodes 7 are disposed on the lower surface of the transparent medium 1. The multiple sensing electrodes 7 are arranged in a two-dimensional array, which may be a rectangular array or a two-dimensional array in other shapes. For the capacitive touch screen, each sensing electrode 7 is a capacitive sensor, and the capacitance of the capacitive sensor is changed when a position corresponding to the capacitive sensor on the touch screen is touched.

Optionally, a protective layer is provided on the sensing electrodes 7 to protect the sensing electrodes 7.

Each sensing electrode 7 is connected to the touch control chip 5 via a wire, and the touch control chip 5 is connected to the wire (not shown in the figures) via an anisotropic conductive film (ACF) 4. The sensing electrode 7 is made of transparent conductive material such as indium tin oxides (ITO), graphene or metal mesh. In a case where the transparent medium 1 is a PET, PC or PMMA film, the touch control chip 5 is bonded onto the PET, PC or PMMA film without packaging, therefore, the cost of package and package detection of the chip is reduced; in addition, since the chip wafer has a small size, the occupied area and the weight of the capacitive touch screen are reduced. Moreover, by the combination of the ITO and the PET, PC or PMMA film, the weight is further reduced and the transparence is increased.

Optionally, a flexible circuit board 3 is connected with the touch control chip 5, and the flexible circuit board 3 is bonded onto the lower surface of the transparent medium 1 via the ACF (not shown in the figures).

The transparent medium 1 is provided with a visible region (not shown in the figures). In practical application, the visible region is a touch region or is included in a touch region. A light shielding layer 2 is provided on the lower surface of the transparent medium 1 and the light shielding layer 2 is located at the outside of the visible region. The light shielding layer 2 is made of ink in various colors or light shielding material capable of being effectively combined with the transparent medium 1. The touch control chip 5, the flexible circuit board 3 and the wires (not shown in the figures) are all provided below the light shielding layer 2, therefore, the wires, the touch control chip 5 and the flexible circuit board 3 provided on the lower surface of the transparent medium 1 can be effectively shielded.

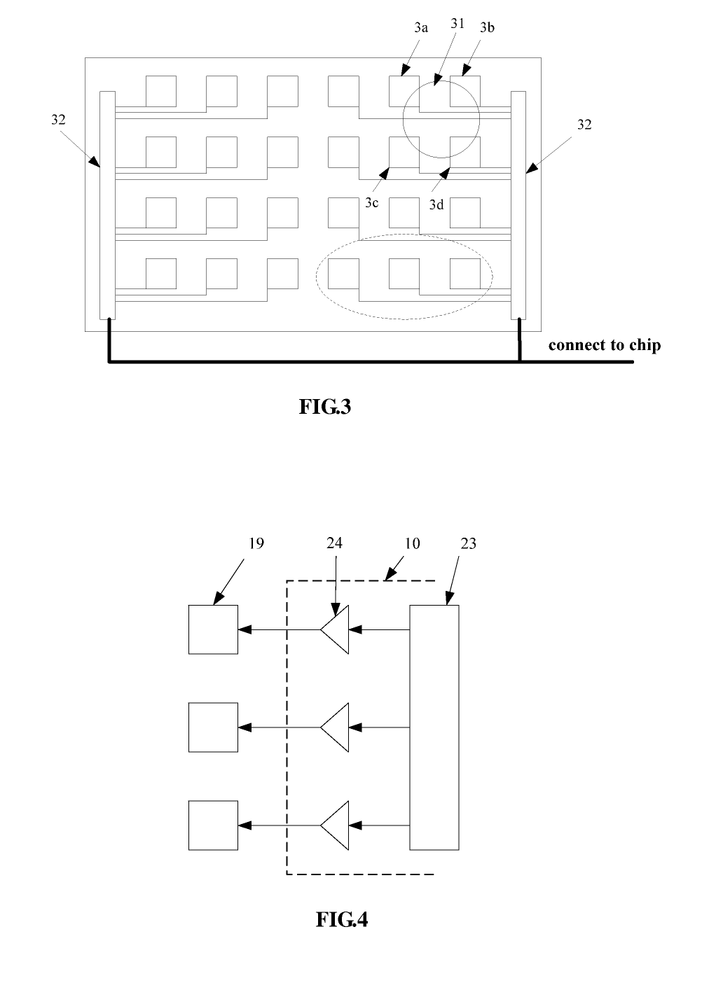

FIG. 2 illustrates a method for manufacturing the capacitive touch screen described above according to an embodiment of the present invention.

Step 21: plating a lower surface of a transparent medium with transparent conductive material, and etching the transparent conductive material to form multiple sensing electrodes, the multiple sensing electrodes being arranged in a two-dimensional array; and

Step 22: bonding a touch control chip onto the lower surface of the transparent medium, and connecting the touch control chip to each of the multiple sensing electrodes via a wire.

The transparent medium may be a transparent film such as a PET film, a PC film or a PMMA film. The lower surface of the transparent medium is plated with transparent conductive material such as ITO, graphene or metal mesh, and then multiple sensing electrodes are formed by etching the transparent conductive material. The multiple sensing electrodes are arranged in a two-dimensional array, which may be a rectangular array or a two-dimensional array in other shapes. For the capacitive touch screen, each sensing electrode is a capacitive sensor, and the capacitance of the capacitive sensor is changed when a position corresponding to the capacitive sensor on the touch screen is touched.

Optionally, a protective layer is provided on the sensing electrodes to protect the sensing electrodes.

In a case where the transparent medium is the PET film, the touch control chip is bonded onto the lower surface of the PET film; in a case where the transparent medium is the PC film, the touch control chip is bonded onto the lower surface of the PC film; or in a case where the transparent medium is the PMMA film, the touch control chip is bonded onto the lower surface of the PMMA film. The above three ways for bonding the touch control chip may be referred to as Chip On PET/PC/PMMA, and COP for short. Each of the multiple sensing electrodes is connected with one end of a wire, and the touch control chip is connected with the other end of the wire via an ACF. The sensing electrode is made of transparent conductive material such as ITO, graphene or metal mesh. The wire may be made of metal material or other conductive materials, such as molybdenum-aluminium-molybdenum, silver paste, ITO or graphene. The chip needs not to be packaged when the COP technology is used, therefore, the cost of packaging and package detection of the chip is reduced; in addition, since the chip wafer has a small size, the occupied area and the weight of the capacitive touch screen are reduced. Moreover, by the combination of the ITO and the PET, PC or PMMA film, the weight of the capacitive touch screen is further reduced and the transparence of the capacitive touch screen is increased.

A flexible circuit board may be bonded onto the lower surface of the transparent medium via an ACF by utilizing a hot pressing technology.

The transparent medium is provided with a visible region. In practical application, the visible region is a touch region or is included in a touch region. A light shielding layer is provided on the lower surface of the transparent medium and the light shielding layer 2 is located at the outside of the visible region. The light shielding layer is made of ink in various colors or light shielding material capable of being effectively combined with the transparent medium. The touch control chip, the flexible circuit board and the wires are all provided below the light shielding layer, therefore, the wires, the touch control chip and the flexible circuit board provided on the lower surface of the transparent medium can be effectively shielded.

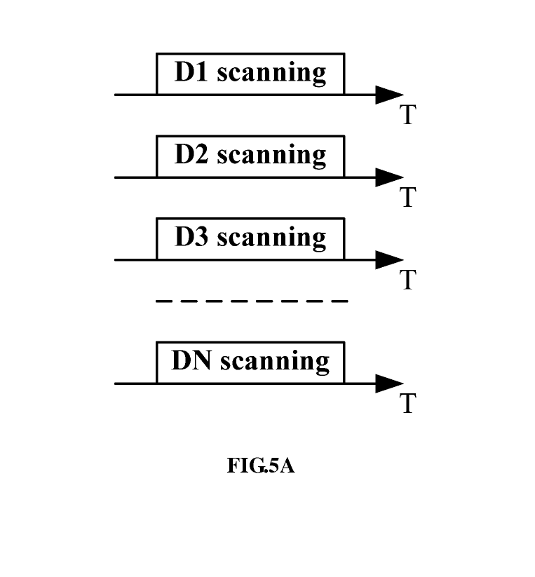

FIG. 3 is a top view of a sensing electrode array according to an embodiment of the present invention. It should be understood by those skilled in the art that, FIG. 3 only illustrates one arrangement of the sensing electrodes, and in other embodiment, the sensing electrodes may be arranged in any two-dimensional array. In addition, the intervals between the sensing electrodes in any direction may be equal or may be different. It should be understood by those skilled in the art that there may be more sensing electrodes than the sensing electrodes shown in FIG. 3.

It should be understood by those skilled in the art that, FIG. 3 only illustrates one shape of the sensing electrodes. In other embodiment, the sensing electrode may be in a shape of a rectangle, a diamond, a circle or an oval, or may be in an irregular shape. The pattern of each sensing electrode may be the same, or may be different. For example, each of the sensing electrodes in the middle may have a diamond structure, and each of the sensing electrodes at the edge may have a triangle structure. In addition, the size of the sensing electrodes may be the same or may be different. For example, the size of the sensing electrode closer to the center is larger than the size of the sensing electrode closer to the edge, which facilitates routing and improves touch accuracy at the edge.

Each sensing electrode is led out via a wire and the wire is arranged in the gaps between the sensing electrodes. In general, the wire is as even and short as possible. In addition, the routing region of the wires should be as narrow as possible with safety distance being ensured, thereby leaving more space for the sensing electrodes and thus improving the sensing accuracy.

Each sensing electrode may be connected to a bus 32 via the wire. The bus 32 connects the wires to the touch control chip directly, or the bus 32 arranges the wires in a certain order and then connects them to the touch control chip. For a large touch screen, the number of the sensing electrodes may be large. In this case, all of the sensing electrodes may be controlled by a single touch control chip; or the sensing electrodes in different regions may be controlled by multiple touch control chips respectively by partitioning the screen into the different regions, where the multiple touch control chips may be clock-synchronized, and in this case, the bus 32 may be divided into several bus sets, so as to be connected with the different touch control chips. The touch control chips may control the same number or the different number of the sensing electrodes.

For the sensing electrode array shown in FIG. 3, the routing may be implemented in the same layer as the sensing electrode array. For a sensing electrode array with other structure, the wires may be arranged in a layer different from the layer of the sensing electrode array and be connected to each of the sensing electrodes via through-holes if the wires are difficult to be arranged in the same layer as the sensing electrode array.

The sensing electrode array shown in FIG. 3 is based on a self-capacitance touch detection principle. Each sensing electrode corresponds to a particular position on the screen. In FIGS. 3, 3a to 3d represent different sensing electrodes and 31 represents a touch. When the touch occurs on a position corresponding to a certain sensing electrode, the charges on the sensing electrode is changed. Therefore, whether there is a touch on the sensing electrode can be determined by detecting the charges (current/voltage) on the sensing electrode. In general, this may be achieved by converting an analog signal to a digital signal with an analog-to-digital converter (ADC). The change of the charges on the sensing electrode is related to the area of the sensing electrode covered by the touch. For example, in FIG. 3, the change of the charges on the sensing electrode 3b or 3d is greater than the change of the charges on the sensing electrode 3a or 3c.

Each position on the screen corresponds to a sensing electrode, and there is no physical connection between the sensing electrodes. Therefore, real multi-touch can be achieved with the capacitive touch screen provided according to the embodiment of the present invention, thereby avoiding ghost points in the self-capacitance touch detection and errors caused by noises accumulation between the electrodes in the prior art, and thus significantly improving the signal-to-noise ratio.

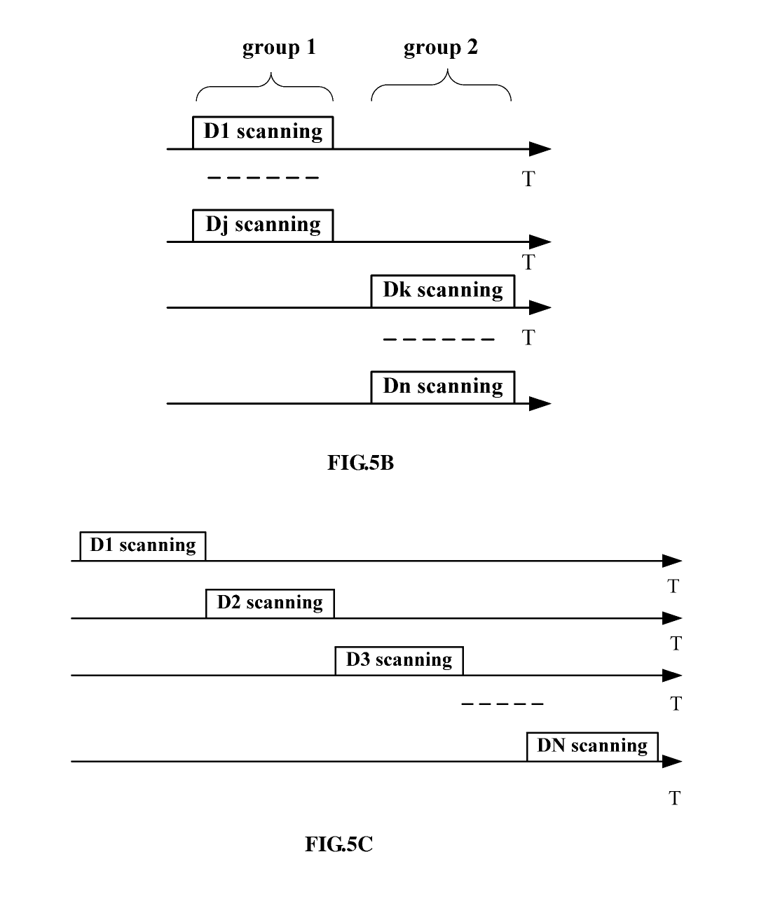

FIGS. 4 to 8 illustrate methods for driving sensing electrodes according to embodiments of the present invention. As shown in FIG. 4, a sensing electrode 19 is driven by a driving source 24, and the driving source 24 may be a voltage source or a current source. The driving sources 24 for different sensing electrodes 19 may have the same structure or different structures. For example, some of the driving sources 24 may be voltage sources, and some of the driving sources 24 may be current sources. In addition, the driving sources 24 for different sensing electrodes 19 may have the same frequency or different frequencies. A timing control circuit 23 controls time sequence of operations of the driving sources 24.

There are many ways of time sequence for driving the sensing electrodes 19. As shown in FIG. 5A, all of the sensing electrodes are driven simultaneously and detected simultaneously. In this way, the time for completing one scanning is the shortest, and the number of the driving sources (which is the same as the number of the sensing electrodes) is the largest. As shown in FIG. 5B, the driving sources for the sensing electrodes are grouped, and each of the groups drive in turn electrodes in particular regions. In this way, the driving sources can be reused, but the scanning time will be increased. However, a compromise may be made between the driving source reuse and the scanning time by selecting appropriate number of groups.

FIG. 5C illustrates a scanning manner of conventional mutual-capacitance touch detection. Provided that there are N driving channels (TXs) and the scanning time for each TX is Ts, the time for scanning one frame is N*Ts. However, by using the method for driving the sensing electrodes according to the present embodiment, all of the sensing electrodes may be detected at a time, and the time for scanning one frame can reach a minimum of Ts. That is, compared with the conventional mutual-capacitance touch detection, the scanning frequency can be increased N times by the solution of the present embodiment.

For a mutual-capacitance touch screen with 40 driving channels, in a case where the scanning time for each driving channel is 500 us, the scanning time for the whole touch screen (one frame) is 20 ms, that is, the frame rate is 50 Hz, which usually can not reach the requirement for good experience. This problem can be solved by the solution of the embodiment of the present invention. By using the sensing electrodes arranged in a two-dimensional array, all of the electrodes can be simultaneously detected, and in the same case where the detection time for each electrode is 500 μs, the frame rate can reach 2000 Hz. This is much better than the requirement of most touch screens. The rest of the scanning data may be utilized by a digital signal processing unit for, for example, anti-interference or touch traces optimization, so as to obtain a better result.

Preferably, the self-capacitance of each sensing electrode is detected. The self-capacitance of the sensing electrode may be the capacitance of the sensing electrode to the ground.

As an example, a charge detection method may be utilized. As shown in FIG. 6, a constant voltage V1 is provided by the driving source 41. The voltage V1 may be positive, negative or equivalent to the ground. S1 and S2 represent two controlled switches, 42 represents the capacitance of the sensing electrode to the ground, and 45 represents a charge receiving module which clamps an input voltage to a specific value V2 and measures an input or output charge quantity. Firstly, S1 is on and S2 is off, the upper plate of Cx is charged to voltage V1 provided by the driving source 41; then S1 is off and S2 is on, and Cx exchanges charges with the charge receiving module 45. Provided that the transferred charge quantity is Q1 and the voltage on the upper plate of Cx becomes V2, Cx=Q1/(V2−V1) is obtained from C=Q/ΔV, thus the capacitance detection is achieved.

As another example, the self-capacitance may be obtained by a current source or by the frequency of the sensing electrode.

Optionally, in a case where multiple driving sources are adopted, when a sensing electrode is detected, the voltage of a driving source for the sensing electrode being detected may be different from the voltage of a driving source for the sensing electrode adjacent to or around the sensing electrode being detected. For convenient illustration, FIG. 7 illustrates only three sensing electrodes: an electrode 57 being detected, and two adjacent electrodes 56 and 58. It should be understood by those skilled in the art that the following examples are also applicable to situations with more sensing electrodes.

A driving source 54, which is connected with the electrode 57 being detected, is connected to a voltage source 51 through a switch S2, to drive the electrode 57 being detected. The sensing electrodes 56 and 58 adjacent to the electrode 57 being detected are connected to driving sources 53 and 55 respectively, and may be connected to the voltage source 51 or a specific reference voltage 52 (e.g., the ground) through switches S1 and S3 respectively. If the switches S1 and S3 are connected to the voltage source 51, that is, the electrode being detected and the adjacent electrodes are driven simultaneously by the same voltage source, the voltage difference between the electrode being detected and the adjacent electrodes are reduced, which facilitates reducing the capacitance of the electrode being detected and avoiding false touch caused by a water drop.

Preferably, the touch control chip is configured to adjust the sensitivity or the dynamic range of touch detection by adjusting parameters of the driving source. The parameters include any of the amplitude, the frequency, and the time sequence or the combination thereof. As an example shown in FIG. 7, the parameters of each driving source (e.g., driving voltage, current and frequency) and the time sequence of the driving sources may be controlled by control logic of a signal driving circuit 50 in the touch control chip. Different circuit operating modes, e.g., high sensitivity, medium sensitivity or low sensitivity, or different dynamic ranges may be adjusted by these parameters.

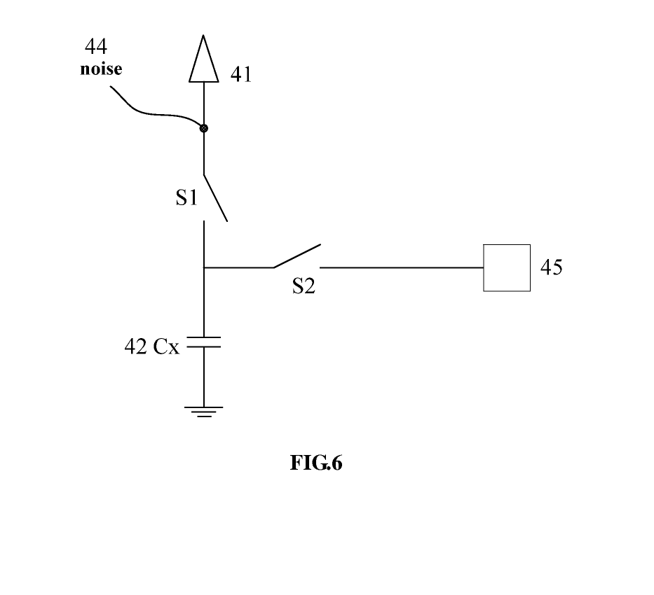

The different circuit operating modes may be applied to different application cases. FIG. 8 illustrates four application cases of the capacitive touch screen according to the embodiments of the invention: a normal finger touch, a floating finger touch, a touch with an active/passive stylus or a tiny conductor, and a touch with a finger in a glove. One or more normal touches and one or more touches with tiny conductors may be detected in conjunction with the parameters described above. It should be understood by those skilled in the art that the signal receiving unit 59 and the signal driving circuit 50 may be implemented in one circuit although they are separate as shown in FIG. 7.

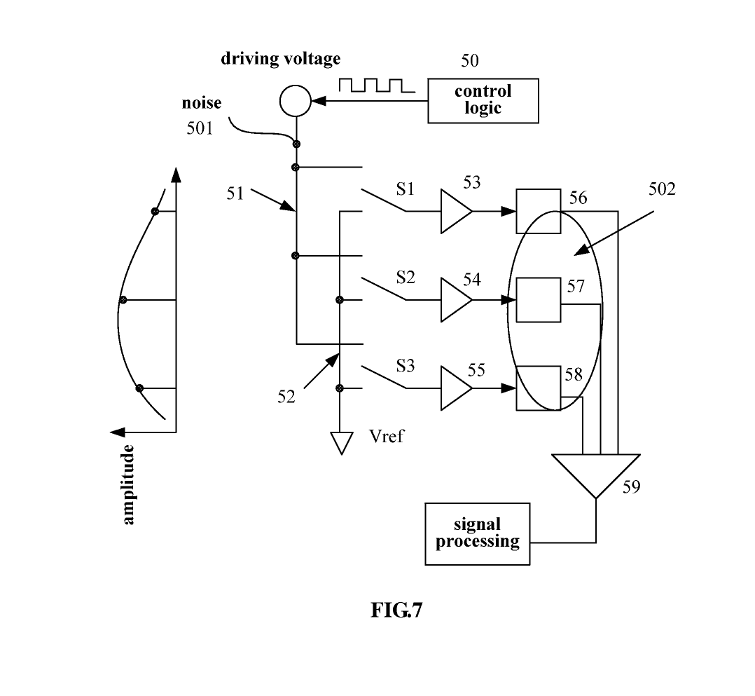

FIG. 9 illustrates a signal flow chart of a touch control chip according to an embodiment of the invention. The capacitance of the sensing electrode is changed when there is a touch on the sensing electrode, and the change is converted into a digital signal through an ADC to recover the touch information. In general, the change of the capacitance is related to the area of the sensing electrode covered by a touch object. The sensing data of the sensing electrode is received by the signal receiving unit 59 and is used to recover the touch information by a signal processing unit.

As an example, a data processing method of the signal processing unit is described in detail as follows.

Step 61: acquiring the sensing data.

Step 62: performing filtering and denoising on the sensing data. This step is to remove noises from an original image as much as possible for subsequent calculation. Spatial-domain filtering, time-domain filtering or threshold filtering may be used in this step.

Step 63: searching for possible touch region. The region includes an actual touch region and an invalid signal. The invalid signal includes a large-area touch signal, a power supply noise signal, a suspended abnormal signal, a water drop signal, etc. The invalid signal may be similar to an actual touch, or may interfere with an actual touch, or may not be parsed as an actual touch.

Step 64: performing exception handing, to remove the above invalid signal and obtain a reasonable touch region.

Step 65: determining coordinates of a touch position by calculating based on the data of the reasonable touch region.

Preferably, the coordinates of the touch position may be determined based on a two-dimensional sensing array. Specifically, the coordinates of the touch position may be determined based on the two-dimensional sensing array by using a centroid algorithm.

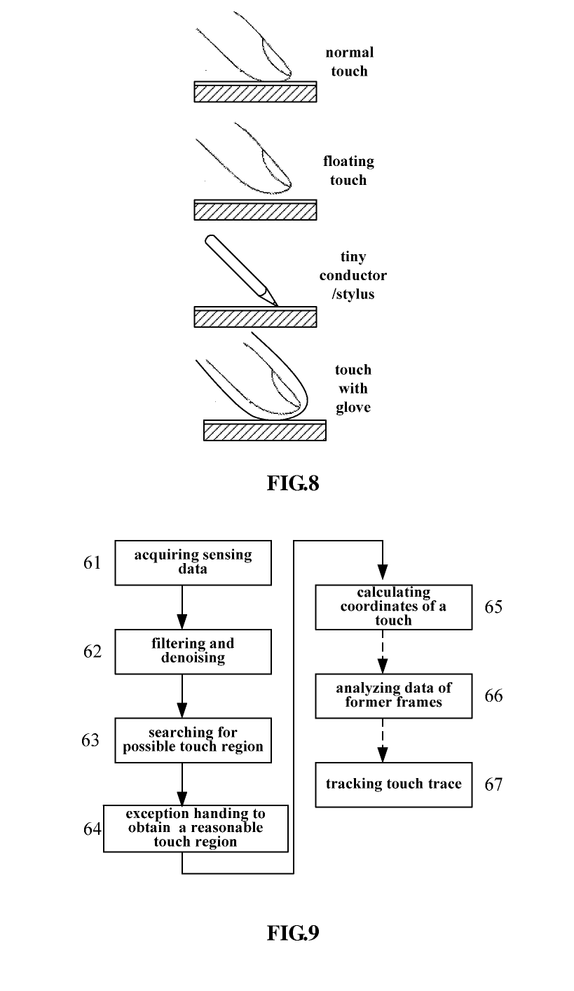

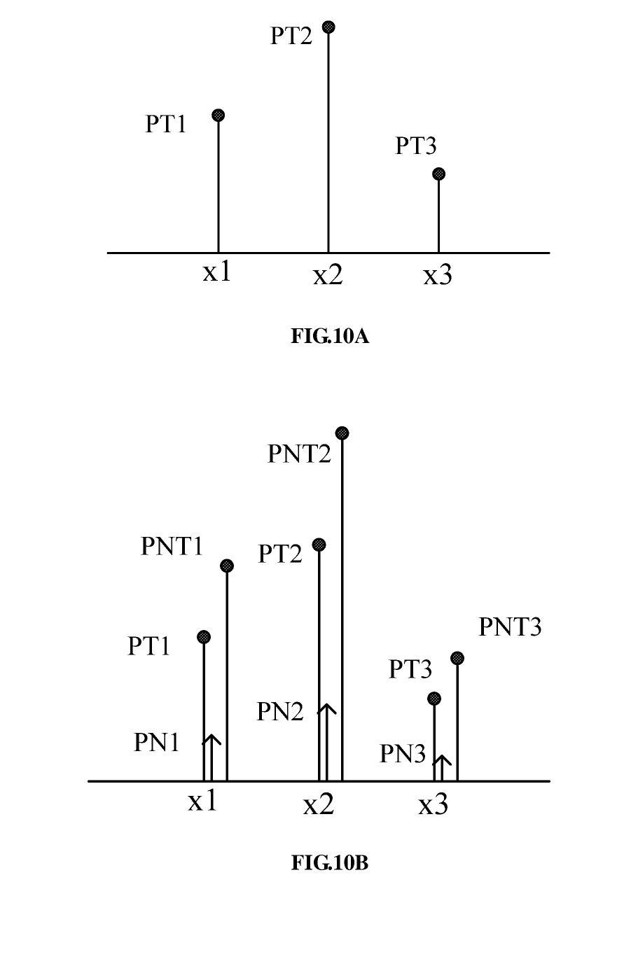

FIG. 10A illustrates an example of calculating the coordinates of a touch position by using the centroid algorithm. Only coordinate in one dimension of the touch position is calculated in the following description for brevity. It should be understood by those skilled in the art that, all coordinates of the touch position may be obtained by using the same or similar method. Provided that the sensing electrodes 56 to 58 shown in FIG. 7 are covered by a finger, the corresponding sensing data are PT1, PT2 and PT3 respectively, and the coordinates corresponding to the sensing electrodes 56 to 58 are x1, x2 and x3 respectively, one coordinate of the touch position by the finger obtained by using the centroid algorithm is:

$${X}_{touch} = \frac{PT 1 * x 1 + PT 2 * x 2 + PT 3 * x 3}{PT 1 + PT 2 + PT 3} . \qquad ( 1 )$$

Optionally, after the coordinate of the touch position is obtained, step 66 may be performed: analyzing data of former frames to obtain data of the current frame based on multi-frame data.

Optionally, after the coordinate of the touch position is obtained, step 67 may further be performed: tracking touch traces based on the multi-frame data. In addition, event information may be obtained and reported based on the user's operation.

With the capacitive touch screen according to the embodiments of the invention, multi-touch can be achieved, while the problem of noise accumulation in the prior art can be solved.

By taking a power supply common-mode noise introduced to a location 501 shown in FIG. 7 as an example, influence of the noise on the calculation of the touch position is analyzed as follows.

In a touch system based on mutual capacitance touch detection in the prior art, there are multiple driving channels (TXs) and multiple receiving channels (RXs), and each RX is connected to all the TXs. When a common-mode interference signal is introduced into the system, the noise will be transmitted through all the RXs because of the connectivity of the RXs. In particular, when multiple noise sources are in one RX, the noises of the noise sources will be accumulated, which will increase the amplitude of the resultant noise. The voltage signal on the capacitor being measured fluctuates because of the noise, and thus false detection will occur on an untouched point.

In the capacitive touch screen provided according to the embodiment of the invention, the sensing electrodes are not physically connected before they are connected into the chip, therefore, the noises can not be transmitted and accumulated among the sensing electrodes and the false detection is avoided.

By taking a voltage detection method as an example, the voltage on the touched electrode is changed because of noise, and the sensing data of the touched electrode is changed consequently. According to a self-capacitance touch detection principle, the sensing value cause by noise and the sensing value caused by a normal touch are all proportional to the area of the electrode covered by the touch.

FIG. 10B illustrates an example of calculating the coordinates of a touch position by using a centroid algorithm in a case where noise exists. Provided that the sensing values caused by a normal touch are PT1, PT2 and PT3, and the sensing values caused by noises are PN1, PN2 and PN3, then (taking the sensing electrodes 56 to 58 as an example):

PT1 ∝ C58, PT2 ∝ C57, PT3 ∝ C56,

PN1 ∝ C58, PN2 ∝ C57, PN3 ∝ C56.

where PN1=K*PT1, PN2=K*PT2, PN3=K*PT3, K is a constant.

In the case that the polarities of the voltages of the driving source and the noise are the same, the final obtained sensing data with voltage superposition is:

PNT1=PN1+PT1=(1+K)*PT1

PNT2=PN2+PT2=(1+K)*PT2

PNT3=PN3+PT3=(1+K)*PT3

the coordinate obtained by using the centroid algorithm is:

$$\begin{matrix}{X}_{touch} = \frac{PNT 1 * x 1 + PNT 2 * x 2 + PNT 3 * x 3}{PNT 1 + PNT 2 + PNT 3} \\ = \frac{( 1 + K ) * PT 1 * x 1 + ( 1 + K ) * PT 2 * x 2 + ( 1 + K ) * PT 3 * x 3}{( PT 1 + PT 2 + PT 3 ) * ( 1 + K )} \\ = \frac{PT 1 * x 1 + PT 2 * x 2 + PT 3 * x 3}{( PT 1 + PT 2 + PT 3 )}\end{matrix} \qquad ( 2 )$$

It can be seen that formula (2) is identical to formula (1). Therefore, the capacitive touch screen according to the embodiments of the invention is immune to the common-mode noise. The finally determined coordinates will not be affected if only the noise does not go beyond the dynamic range of the system.

A valid signal may be pulled down in a case where the polarities of the voltages of the driving source and the noise are opposite. It can be seen from the above analysis that, the finally determined coordinate will not be affected if the valid signal pulled down can be detected. The data of the current frame is invalid if the valid signal pulled down can not be detected. However, the data of the current frame can be recovered based on multi-frame data since the scanning frequency of the capacitive touch screen according to the embodiments of the invention may be up to N (N is usually greater than 10) times of a normal scanning frequency. It should be understood by those skilled in the art that, a normal report rate may not be affected by the process with the multi-frame data since the scanning frequency is much greater than an actually required report rate.

Similarly, in a case where the noise goes beyond the dynamic range of the system within a limit, the current frame may be revised based on the multi-frame data, so as to obtain accurate coordinates. This inter-frame processing method is also applicable to radio frequency and interference from other noise sources such as a liquid crystal display module.

The above description of the embodiments disclosed herein enables those skilled in the art to implement or use the present invention. Numerous modifications to the embodiments will be apparent to those skilled in the art, and the general principle herein can be implemented in other embodiments without deviation from the scope of the present invention. Therefore, the present invention will not be limited to the embodiments described herein, but in accordance with the widest scope consistent with the principle and novel features disclosed herein.

1. A capacitive touch screen, comprising:
a transparent medium;
a plurality of sensing electrodes disposed on a lower surface of the transparent medium, the plurality of sensing electrodes being arranged in a two-dimensional array; and
a touch control chip bonded onto the lower surface of the transparent medium, the touch control chip being connected with each of the plurality of sensing electrodes via a wire.

2. The capacitive touch screen according to claim 1, further comprising:
a flexible circuit board connected with the touch control chip, the flexible circuit board being bonded onto the lower surface of the transparent medium via an anisotropic conductive film ACF.

3. The capacitive touch screen according to claim 1, wherein the touch control chip is connected with the wire via an ACF.

4. The capacitive touch screen according to claim 1, wherein the transparent medium is provided with a visible region, a light shielding layer is disposed on the lower surface of the transparent medium, and the light shielding layer is located at the outside of the visible region.

5. The capacitive touch screen according to claim 4, wherein the touch control chip, the flexible circuit board and the wire are all disposed below the light shielding layer.

6. The capacitive touch screen according to claim 1, wherein the transparent medium is a polyethylene terephthalate PET film, a polycarbonate PC film or a polymethylmethacrylate PMMA film, and the sensing electrode is made of indium tin oxides, graphene or metal mesh.

7. The capacitive touch screen according to claim 6, wherein
the transparent medium is the PET film, and the touch control chip is bonded onto a lower surface of the PET film; or
the transparent medium is the PC film, and the touch control chip is bonded onto a lower surface of the PC film; or
the transparent medium is the PMMA film, and the touch control chip is bonded onto a lower surface of the PMMA film.

8. The capacitive touch screen according to claim 1, wherein the sensing electrode is in a shape of a rectangle, a diamond, a circle or an oval, and the plurality of sensing electrodes have a same size or different sizes.

9. The capacitive touch screen according to claim 1, wherein the touch control chip is configured to detect self-capacitance of each sensing electrode.

10. The capacitive touch screen according to claim 9, wherein the touch control chip is configured to detect self-capacitance of each sensing electrode by:
driving the sensing electrode by using a voltage source or a current source; and
detecting a voltage, a frequency or a charge quantity on the sensing electrode.

11. The capacitive touch screen according to claim 9, wherein the touch control chip is configured to detect self-capacitance of each sensing electrode by:
driving and detecting the sensing electrode, and driving the remaining sensing electrodes simultaneously; or
driving and detecting the sensing electrode, and driving sensing electrodes around the sensing electrode simultaneously,
wherein a signal for driving the sensing electrode and a signal for driving the remaining sensing electrodes or a signal for driving the sensing electrodes around the sensing electrode are same voltage signals or same current signals, or are different voltage signals or different current signals.

12. The capacitive touch screen according to claim 10, wherein
the voltage source or the current source has a same frequency for the plurality of sensing electrodes; or
the voltage source or the current source has two or more frequencies for the plurality of sensing electrodes.

13. The capacitive touch screen according to claim 9, wherein the touch control chip is configured to detect self-capacitance of each sensing electrode by:
detecting the plurality of sensing electrodes simultaneously; or
detecting the plurality of sensing electrodes group by group.

14. The capacitive touch screen according to claim 9, wherein the touch control chip is configured to determine a touch position according to a two-dimensional sensing array.

15. The capacitive touch screen according to claim 10, wherein the touch control chip is further configured to adjust sensitivity or dynamic range of a touch detection by means of parameters of the voltage source or the current source, wherein the parameters comprise any of amplitude, frequency and time sequence or a combination thereof.

16. A method for manufacturing a capacitive touch screen, comprising:
plating a lower surface of a transparent medium with transparent conductive material, and etching the transparent conductive material to form a plurality of sensing electrodes, the plurality of sensing electrodes being arranged in a two-dimensional array; and
bonding a touch control chip onto the lower surface of the transparent medium, and connecting the touch control chip to each of the plurality of sensing electrodes via a wire.

17. The method according to claim 16, wherein the method further comprises, after bonding a touch control chip onto the lower surface of the transparent medium,
bonding a flexible circuit board onto the lower surface of the transparent medium via an anisotropic conductive film ACF by utilizing a hot pressing technique, and connecting the flexible circuit board to the touch control chip.

18. The method according to claim 16, wherein the connecting the touch control chip to each of the sensing electrodes via a wire comprises:
connecting each of the plurality of sensing electrodes to one end of a wire, and connecting the touch control chip to the other end of the wire via an ACF.

19. The method according to claim 16, wherein the method further comprises, after etching the transparent conductive material to form the plurality of the sensing electrodes,
providing the transparent medium with a visible region, and providing a light shielding layer on the lower surface of the transparent medium, wherein the light shielding layer is located at the outside of the visible region.

20. The method according to claim 19, wherein the touch control chip, the flexible circuit board and the wire are all disposed below the light shielding layer.

21. The method according to claim 16, wherein the transparent medium is a polyethylene terephthalate PET film, a polycarbonate PC film or a polymethylmethacrylate PMMA film, and the transparent conductive material is indium tin oxides, graphene or metal mesh.

22. The method according to claim 21, wherein the bonding a touch control chip onto the lower surface of the transparent medium comprises:
in a case where the transparent medium is the PET film, bonding the touch control chip onto a lower surface of the PET film;
in a case where the transparent medium is the PC film, bonding the touch control chip onto a lower surface of the PC film; or
in a case where the transparent medium is the PMMA film, bonding the touch control chip onto a lower surface of the PMMA film.

23. The method according to claim 16, wherein the sensing electrode is in a shape of a rectangle, a diamond, a circle or an oval, and the plurality of sensing electrodes have a same size or different sizes.
